(19) United States
(12) Patent Application Publication
(10) Pub. No.: US 2026/0250456 A1
(43) Pub. Date: Aug. 27, 2026

(54) UREA-CONTAINING POLYURETHANE ACRYLATE RESIN, COMPOSITE MATERIAL, AND METHOD FOR PREPARING COMPOSITE MATERIAL THEREOF

(71) Applicant: Swancor Innovation & Incubation Co., Ltd., Nantou County (TW)

(72) Inventors: TING-HSUAN CHIANG, Nantou County (TW); Jun-Qi Kao, Nantou County (TW)

(73) Assignee: Swancor Innovation & Incubation Co., Ltd., Nantou County (TW)

(21) Appl. No.: 19/420,770

(22) Filed: Dec. 16, 2025

(30) Foreign Application Priority Data
Feb. 25, 2025 (CN) 202510209076.3

(51) Int. Cl. C08G 18/83; C08G 18/10; C08G 18/67; C08J 5/24

(52) U.S. Cl. CPC C08G 18/833; C08G 18/10; C08G 18/672; C08J 5/243; C08J 2375/16

(57) ABSTRACT

A urea-containing polyurethane acrylate resin is provided, which is prepared by: amide-forming the isocyanate groups in a polyurethane acrylate polymer with an amine compound to form urea groups, wherein the polyurethane acrylate polymer is prepared by reacting a hydroxyl-containing (meth)acrylate compound with a urethane prepolymer, the urethane prepolymer is prepared by reacting an isocyanate compound with a polyol compound, and the equivalent ratio of the isocyanate groups in the isocyanate compound to the hydroxyl groups in the polyol compound is 15:1 to 1:1. A urea-containing polyurethane acrylate resin, a composite material, and a method for preparing a composite material are also provided.

### CROSS-REFERENCE TO RELATED APPLICATION

This application claims the priority benefit of China application serial no. 202510209076.3, filed on Feb. 25, 2025. The entirety of the above-mentioned patent application is hereby incorporated by reference herein and made a part of this specification.

### BACKGROUND

### Technical Field

The disclosure relates to a resin composition, a composite material, and a preparation method of a resin, and in particular to a resin composition and a composite material including a urea-containing polyurethane acrylate resin, and a preparation method of the urea-containing polyurethane acrylate resin.

### Description of Related Art

Polyurethane acrylate (PUA) resin is widely applied in electronic devices, building materials, coatings, or paints. Further, modified PUA resin have been reported. For example, U.S. Pat. No. 4,605,723 describes urethane urea acrylate resins based on isophorone diisocyanate (IPDI), polyether or polyesters and trimethylhexamethylenediamine (TMD). However, how to modify the polyurethane acrylate resin to achieve broader applications and/or improved quality remains a challenging. In particular, there is a need for fiber composite material with improved inter-layer shear strength (ILSS), which are at least comparable or even superior to commercially available vinyl resin or/and or epoxy fiber composites. Further, a PUA resin should be provided which can be formed into a composite material without heating.

### SUMMARY

The disclosure provides a resin composition, a composite material, and a preparation method of a urea-containing polyurethane acrylate resin, which may be widely applied and have improved quality.

A resin composition of the disclosure includes a urea-containing polyurethane acrylate resin. The urea-containing polyurethane acrylate resin is prepared by amidation of an isocyanate group in a polyurethane acrylate polymer with an amine compound to form a urea group, wherein the polyurethane acrylate polymer is prepared by reacting a hydroxyl-containing (meth)acrylate compound with a urethane prepolymer, the urethane prepolymer is prepared by reacting an isocyanate compound with a polyol compound, and the equivalent ratio of the isocyanate groups in the isocyanate compound to the hydroxyl groups in the polyol compound is 15:1 to 1:1.

The resin composition of the disclosure includes a urea-containing polyurethane acrylate resin represented by the [Formula 1] described later.

A composite material of the disclosure includes the resin composition and a carbon fiber.

A method for preparing a composite material of the disclosure includes applying a resin composition comprising the urea-containing polyurethane acrylate resin to a carbon fiber.

Based on the above, since the polyurethane acrylate resin used in the resin composition and the composite material of the disclosure is a modified urea-containing polyurethane acrylate resin, the resin composition and the composite material may be widely applied and have improved quality.

### DESCRIPTION OF THE EMBODIMENTS

In this specification, unless otherwise specified, when the prefix “about” is used to express a numerical value, the numerical value may be directly represented as that specific value. Additionally, when the prefix “about” is used to express the numerical value, the numerical value may include a measurement error range that is typically included in general measurement methods or an error propagation range derived from calculations.

In this specification, when expressing numerical values or numerical ranges, possible embodiments include a specific value, another specific value, or a range between the specific value and the other specific value. For example, when expressing a range from 1 to 10 and additionally specifying the values 3 and 7, an embodiment may include the specific value 1, the specific value 3, the specific value 7, the specific value 10, the range from 1 to 3, the range from 1 to 7, the range from 3 to 7, the range from 3 to 10, or the range from 7 to 10. For example, when specifying the specific values 2, 5, and 8, an embodiment may include the specific value 2, the specific value 5, the specific value 8, the range from 2 to 5, the range from 2 to 8, or the range from 5 to 8.

### 1. UREA-CONTAINING POLYURETHANE ACRYLATE RESIN

The urea-containing polyurethane acrylate resin may be obtained by reacting an isocyanate compound, a polyol compound, a hydroxyl-containing (meth)acrylate compound, and an amine compound.

### 1.1 Isocyanate Compound

The isocyanate compound is a mixture containing at least a portion of trifunctionalized isocyanate compounds, for example, an isocyanate compound containing a portion of compounds each having at least three isocyanate group (NCO). Generally, the isocyanate compound can contain 40-90 wt %, better 50-80 wt % of tri- or higher functionalized isocyanate compounds, better trifunctionalized isocyanate compounds, based on the total weight of the isocyanate compound. Generally, the isocyanate compound can contain polymeric MDI (abbreviated as pMDI). Suitable pMDI can comprise of a mixture of reactive monomers and oligomers of MDI. In one embodiment, the monomer fraction accounts for approximately 45-50 wt % of the pMDI and it can contain a blend of isomers, better 4,4′ MDI, 2,4′-MDI and 2,2′-MDI. The oligomer fraction of pMDI can comprise an isomeric mixture of oligomers with functionality higher than two. Suitable fractions are illustrated below. Suitable pMDI can have a free isocyanate content of 20-40 wt. %, e.g. about 31-32 wt % and an average functionality of 2.1 to 3, better 2.3-2.9, e.g. about 2.7. Commercially available isocyanate compound may include but are not limited to: Tosoh Corporation, model: MR200, NM; Wanhua Chemical, model: PM200, MDI-50; BASF SE, model: M20S; Covestro AG, model: 44V20; Huntsman Corporation, model: 5005.

The disclosure does not limit the isocyanate compound to a single compound. Taking an isocyanate compound in the form of a polymer as an example, the isocyanate compound may be a mixture of polymer and monomer, such as a mixture of pMDI and toluene diisocyanate (TDI) or a mixture of pMDI and isophorone diisocyanate (IPDI); or may be a mixture of polymers of multiple monomers; or may be a copolymer, such as diphenylmethane diisocyanate (MDI-50). In an embodiment the isocyanate compound does not contain isophorone diisocyanate (IPDI).

In an embodiment, the poly(methylene phenyl isocyanate) (such as Wanhua Chemical, model: PM200, with an isocyanate group content of about 2.083 equivalents) includes a polymeric methylene diphenyl diisocyanate (MDI). Its chain extension reaction with a polyol compound, such as polypropylene glycol, provides support for an embodiment where R3 in [Formula 1] could be derived from a tri-isocyanate or higher functional isocyanate structure.

### 1.2 Polyol Compound

The polyol compound is a difunctionalized polyol compound, for example, a difunctionalized polyether polyol compound, including but not limited to polyoxyethylene ether, polyoxyethylene alkyl ether, polyoxypropylene ether, polyoxypropylene alkyl ether, or polytetrahydrofuran. In the above embodiments, although the polyol compound is exemplified as a polymer, the disclosure is not limited thereto, and the polyol compound may also be in a non-polymer form.

The disclosure does not limit the polyol compound to a single compound. Taking a difunctionalized polyol compound in the form of a polymer as an example, the polyol compound may be a polymer of a single monomer; or may be a mixture of polymers of multiple monomers; or may be a copolymer.

In an embodiment, when the difunctionalized polyol compound is in the form of a polymer, a number average molecular weight thereof is better about 2000 g/mol or less.

### 1.3 Hydroxyl-Containing (Meth)acrylate Compound

In the disclosure, hydroxyl-containing (meth)acrylate is an abbreviation for “hydroxyl-containing acrylate” or “hydroxyl-containing methacrylate.” Multiple types of hydroxyl-containing (meth)acrylate compounds may be used in combination. Specifically, the hydroxyl-containing (meth)acrylate compound may include, but is not limited to, at least one or more of the following: hydroxyethyl acrylate, hydroxyethyl methacrylate, hydroxypropyl acrylate, or hydroxypropyl methacrylate.

### 1.4 Amine Compound

The amine compound may include an amine polymer, a monoamine compound, a diamine compound, or combinations thereof. The amine polymer may be, for example, a polyetheramine, or a polyetherdiamine, in particular having a number average molecular weight of about 400 g/mol or less. The monoamine compound may include a primary aliphatic amine, a secondary aliphatic amine, a primary alicyclic amine, a secondary alicyclic amine, or combinations thereof. An example of the secondary aliphatic amine is dibutylamine. The diamine compound may include a primary aliphatic amine, a primary alicyclic amine, a secondary alicyclic amine, or combinations thereof Δn example of the primary aliphatic amine is polyetheramine (D230). JEFFAMINE D-230 polyetheramine is a difunctional, primary amine with an average molecular weight of about 150-400, e.g. 230. The primary amine groups are located on secondary carbon atoms at the end of the aliphatic polyether chain.

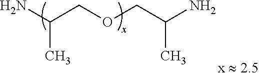

Examples of the primary alicyclic amine include isophorone diamine (IPDA) and 4,4′-diaminodicyclohexylmethane (PACM). An example of the secondary alicyclic amine is piperazine.

In an alternative embodiment the amine compound does not include trimethylhexamehtylenediamine (TMD).

### 1.5 Diluent Monomer

The diluent monomer has a functional group suitable for reaction; or may form a corresponding free radical group. In this way, a polymer chain may be formed with a corresponding reactant through a continuous addition method to adjust viscosity/flowability. Therefore, the diluent monomer may also be referred to as a viscosity-adjusting monomer. In selection, the diluent monomer may be selected based on the type of the isocyanate compound, polyol compound, hydroxyl-containing (meth)acrylate compound, or amine compound. More appropriately, the diluent monomer may be a compound structurally similar to or having the same functional group as the isocyanate compound, polyol compound, hydroxyl-containing (meth)acrylate compound, or amine compound to facilitate the progress of the continuous addition polymerization reaction. For example, the diluent monomer may be selected from one or more of methyl (meth)acrylate, ethyl (meth)acrylate, hydroxyethyl (meth)acrylate, propyl (meth)acrylate, hydroxypropyl (meth)acrylate, tetrahydrofuran (meth)acrylate, isobornyl (meth)acrylate, cyclohexyl (meth)acrylate, styrene, methylstyrene, or vinyltoluene.

In an embodiment, based on a total amount of 100 parts by weight of the urea-containing polyurethane acrylate resin ultimately formed in a subsequent reaction, a total added amount of the diluent monomer is from 30 parts by weight to 45 parts by weight.

### 1.6 Inhibitor

The addition of an inhibitor may enhance the stability of the resin composition. In an embodiment, the inhibitor may include a phenolic compound, for example, 2,5-dihydroxytoluene or 2,6-di-tert-butylhydroxytoluene.

In an embodiment, based on a total amount of 100 parts by weight of the urea-containing polyurethane acrylate resin composition ultimately formed in a subsequent reaction, a total amount of the inhibitor is from 0.01 parts by weight to 0.03 parts by weight.

### 1.7 Proportional Relationship Among Reactants

From the perspective of reagent formulation, it is more straightforward to describe the usage amount of each component in the composition in terms of weight or weight ratio relationships. However, from the perspective of the reactivity between components, considering factors such as the number and/or type of functional groups in a compound (particularly a difunctionalized compound intended for a specific reaction purpose) and the actual composition ratio in commercially available reagents, it may be more accurate to describe the relationship in terms of the molar ratio or molar equivalent ratio (abbreviated as equivalent ratio) of the compounds or their functional groups. The relationship between the molar ratio or equivalent ratio of functional groups and the weight or weight ratio of each component in the composition may be derived and calculated using appropriate detection methods, such as titration, infrared spectrum (IR spectrum), or nuclear magnetic resonance spectrum (NMR spectrum), but the disclosure is not limited thereto.

In an embodiment, an equivalent ratio of the isocyanate group in the isocyanate compound to the hydroxyl group in the polyol compound is from 15:1 to 1:1; preferably, from 10:1 to 3:1; much better, from 9:1 to 3:1.

In an embodiment, an equivalent ratio of the hydroxyl group in the polyol compound to the amino group in the amine compound is from 9:1 to 7:3.

In an embodiment, an equivalent ratio of the hydroxyl group in the hydroxyl-containing (meth)acrylate compound to the isocyanate group in the isocyanate compound is from 1:1.1 to 1:1.5.

### 2. SYNTHESIS METHOD OF UREA-CONTAINING POLYURETHANE ACRYLATE RESIN

### 2.1 Prepolymerization Reaction

First, the isocyanate compound and the diluent monomer are mixed and heated for later use as a first reaction reagent. A suitable heating temperature may range from 40° C. to 70° C., for example, from 45° C. to 60° C.

Then, the polyol compound is added to the first reaction reagent maintained at an appropriate temperature to perform a prepolymerization reaction, thereby obtaining a corresponding urethane prepolymer.

In an embodiment, the prepolymerization reaction may further include adding a catalyst. The catalyst may include an organometallic catalyst (such as tin, zinc, bismuth, or titanium) or an organic base catalyst. An example of the organometallic catalyst includes dibutyltin dilaurate (DBTDL). An example of the organic base catalyst includes 1,4-diazabicyclo[2.2.2]octane (DABCO).

In an embodiment, based on a total amount of 1 kilogram of the urea-containing polyurethane acrylate resin ultimately formed in a subsequent reaction, an amount of the catalyst added is from 50 milligrams (mg) to 200 milligrams.

In an embodiment, the prepolymerization reaction may further include adding an inhibitor to reduce or slow down unwanted polymerization reactions. Examples of the inhibitor may include butylated hydroxytoluene (BHT) or 2,5-dihydroxytoluene.

In an embodiment, after the addition of the polyol compound is completed, the reaction may be further maintained at the appropriate temperature for a sufficient period, for example, from 1 hour to 4 hours. In an embodiment, whether a sufficient proportion or amount of urethane prepolymer has been formed may be determined by appropriate detection methods, such as viscosity measurement, spectral analysis, sample titration, or thermal analysis.

### 2.2 Polymerization Reaction

Then, after obtaining a sufficient proportion or amount of the urethane prepolymer, the hydroxyl-containing (meth)acrylate compound is added to the urethane prepolymer maintained at the appropriate temperature to perform a polymerization reaction, thereby obtaining a polyurethane acrylate polymer.

In an embodiment, based on a total added amount of the entire urethane prepolymer and the hydroxyl-containing (meth)acrylate compound, a total molar amount of the isocyanate group in the urethane prepolymer is greater than a total molar amount of the hydroxyl group in the hydroxyl-containing (meth)acrylate compound. That is, in the obtained polyurethane acrylate polymer, the isocyanate group remains present.

In an embodiment, after the addition of the hydroxyl-containing (meth)acrylate compound is completed, the reaction may be further maintained at an appropriate temperature for a sufficient period, for example, from 1 hour to 4 hours. In an embodiment, whether a sufficient proportion or amount of the polyurethane acrylate polymer has been formed may be determined by the appropriate measurement methods.

### 2.3 Modification Reaction

Next, the amine compound is added to the polyurethane acrylate polymer maintained at the appropriate temperature to perform a modification reaction. The modification reaction essentially involves amidation of the residual isocyanate group in the polyurethane acrylate polymer with the amine compound to form a urea group.

In an embodiment, based on a total added amount of the entire urethane prepolymer, the hydroxyl-containing (meth)acrylate compound, and the amine compound, a sum of a molar amount of the hydroxyl group in the hydroxyl-containing (meth)acrylate compound and a molar amount of the amino group in the amine compound is greater than a total molar amount of the isocyanate group in the urethane prepolymer. That is, after completing the modification reaction, the residual isocyanate group in the polyurethane acrylate polymer may be substantially amidated. This is defined as a percentage ratio of a total weight of the isocyanate group to a total weight of the polyurethane acrylate polymer (i.e., a weight percentage of the isocyanate group (hereinafter referred to as the NCO value)) being less than 0.5%. The NCO value may be measured according to standard methods, such as ISO 14896:2009 Plastics—Polyurethane raw materials—Determination of isocyanate content.

In an embodiment, the amine compound may be continuously/evenly added within a range of 5 minutes to 40 minutes (better, within a range of 10 minutes to 30 minutes), for example, by a dropwise addition method.

An appropriate reaction temperature and an appropriate amine compound addition rate may facilitate amidation of the isocyanate group. However, if a locally instantaneous concentration of the added amine compound in the overall reactant is too high, unexpected reactions may be induced (such as excessive or unintended crosslink), which may alter subsequent reactivity or physical properties (such as viscosity, glass transition temperature (Tg), tensile strength, or impact strength). Therefore, the amine compound must be added continuously and evenly. Furthermore, the reaction between an isocyanate group and an amine group is typically highly exothermic. Therefore, in addition to the continuous and even addition of the amine compound, meticulous control of the reaction temperature can be crucial. The reaction vessel may be equipped with a cooling system to dissipate the heat generated during the amidation, ensuring the temperature is maintained within the desired range (e.g., 40-100° C.; or 40-60° C. as shown in the following examples). Failure to control this exotherm could lead to a rapid increase in viscosity or even premature gelation of the resin, negatively impacting the properties of the final product.

In an embodiment, after completing the addition of the amine compound, the reaction may be further maintained at an appropriate temperature for a sufficient period, for example, from 1 hour to 2 hours. In an embodiment, whether the residual isocyanate group has been substantially amidated into a urea group may be determined by measuring the NCO value using the standard method.

### 3. UREA-CONTAINING POLYURETHANE ACRYLATE RESIN

The urea-containing polyurethane acrylate resin synthesized by the method may include a polymer represented by the following [Formula 1].

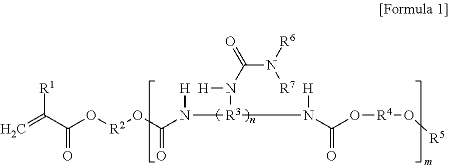

In [Formula 1], R¹ is hydrogen or methyl group. R² is an organic group containing an alkyl group, such as a connecting alkyl group containing one to three carbon atoms (i.e., —CH2-, —C₂H₄—, or —C₃H₆—). R³ is an organic group containing an aromatic group, such as a phenyl group,

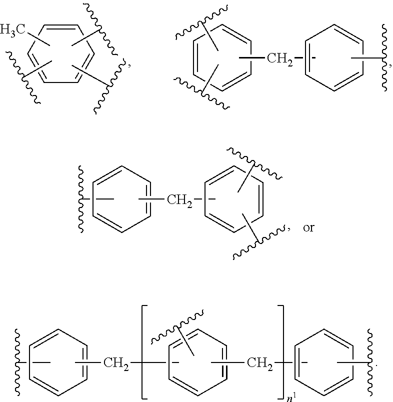

n¹ is an integer of 1 or more, for example, up to 6, better from 1 to 3. R⁴ is an organic group, such as an alkyl group, an alkenyl group, or an alkyl ether group. The alkyl group may be, for example, a connecting alkyl group containing one to three carbon atoms. The alkenyl group may be, for example, an allyl group. The alkyl ether group may be, for example, an ether group in which two independently connecting alkyl groups contain one to four carbon atoms, including but not limited to a dimethyl ether group (i.e., —CH₂—O—CH₂—), a methyl ethyl ether group (i.e., —CH₂—O—C₂H₄—), a diethyl ether group (—C₂H₄—O—C₂H₄—), a dipropyl ether group (—C₃H₆—O—C₃H₆—), or a dibutyl ether group (—C₄H₈—O—C₄H₈—).

In [Formula 1], R⁵ is a connecting group represented by the following [Formula 2].

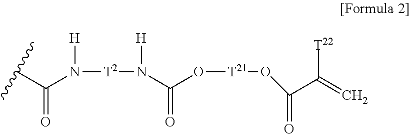

In [Formula 2], T²¹ is an organic group, for example, an alkyl group, an alkenyl group, or an alkyl ether group. The definition thereof is the same as R⁴ in the previous paragraph.

In [Formula 2], T² is an organic group containing an aromatic group, such as a phenyl group,

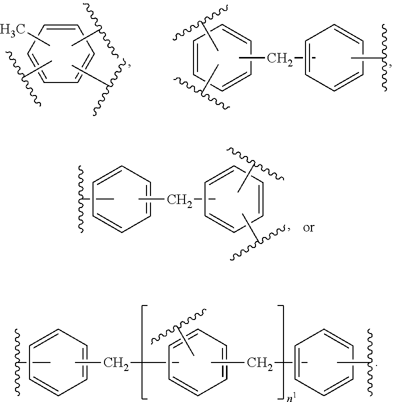

n² is an integer of 1 or more, for example, from 1 to 3.

In [Formula 2], T²² is hydrogen or methyl group.

In [Formula 1], R⁶ is an organic group, for example, a nitrogen-containing organic group. R⁷ is hydrogen or a cyclic organic moiety co-constructed with R⁶.

In [Formula 1], m and n are each an integer of 1 or more. Based on physical property considerations, m is better less than 100, and n is better less than 100. Much better m is 20 to 60. Much better n is 20 to 60.

In an embodiment, the urea-containing polyurethane acrylate resin of the disclosure may be represented by [Formula 1-1], [Formula 1-2], [Formula 1-3], [Formula 1-4], and [Formula 1-5] as shown below.

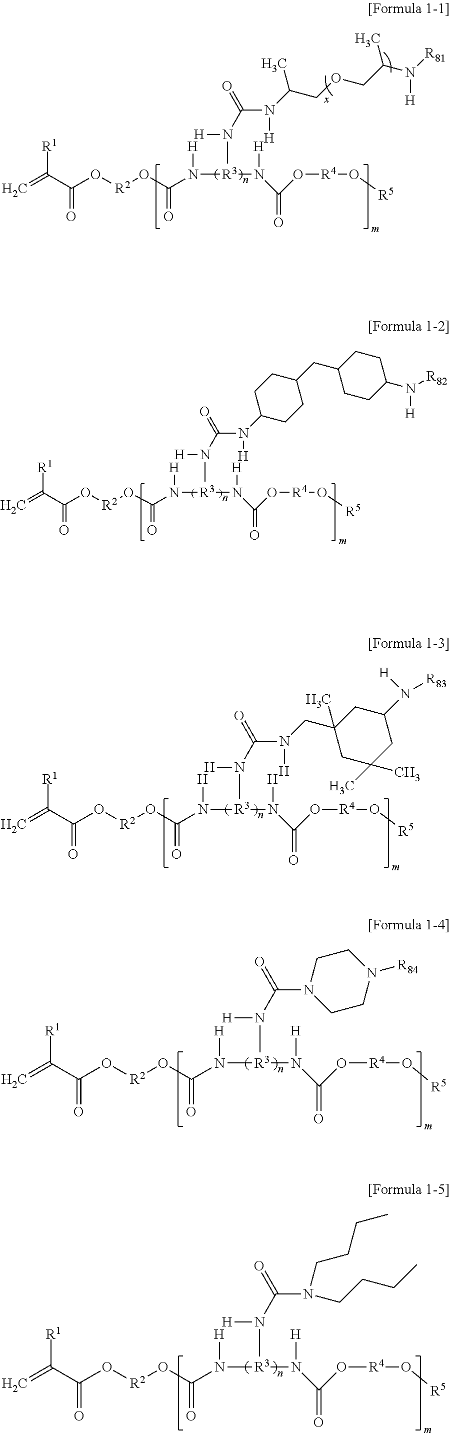

In [Formula 1-1], [Formula 1-2], [Formula 1-3], [Formula 1-4], and [Formula 1-5], R¹, R², R³, R⁴, R⁵, m, and n are defined the same as in [Formula 1].

In [Formula 1-1], [Formula 1-2], [Formula 1-3], [Formula 1-4], and [Formula 1-5], R⁸¹, R⁸², R⁸³, and R⁴ are each independently hydrogen or an organic group represented by the following formula

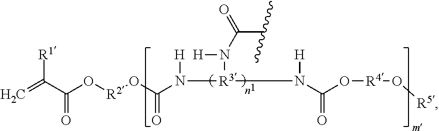

where R^{1′}, R^{2′}, R^{3′}, R^{4′}, R^{5′}, m′, and n′ are defined the same as R¹, R², R³, R⁴, R⁵, m, and n, respectively.

In an embodiment, the formation of the urea group in the urea-containing polyurethane acrylate resin may be further detected by a nuclear magnetic resonance spectrometer. In an embodiment, when the urea-containing polyurethane acrylate resin is analyzed using solution nuclear magnetic resonance spectroscopy, two separate signal peaks with a separation greater than 0.5 ppm may be observed in the range of 8 to 10 ppm in the hydrogen spectrum, which may be inferred to be generated by the active hydrogen of the amide group and the urea group, respectively. Since the urea-containing polyurethane acrylate resin molecule contains polar groups, the active hydrogen of the amide group and the urea group is affected by intramolecular and/or intermolecular hydrogen bonding interactions, causing the detected signal peaks to appear at a downfield shift position.

### 4. RESIN COMPOSITION

The resin composition at least includes the urea-containing polyurethane acrylate resin. That is, the resin composition at least includes a resin obtained by reacting an isocyanate compound, a polyol compound, a hydroxyl-containing (meth)acrylate compound, and an amine compound.

In an embodiment, the resin composition may further include one or more additives. The additives may be appropriately added during the synthesis of the urea-containing polyurethane acrylate resin and/or after the synthesis is completed. That is, the additives may be a part of the resin composition.

The additives may include a diluent monomer, a flame retardant, an inhibitor, a release agent, a curing agent, a curing promoter, a viscosity modifier, a wetting dispersant, or a low shrinkage agent, but the disclosure is not limited thereto.

### 5. APPLICATIONS OF THE RESIN COMPOSITION—COMPOSITE MATERIAL

In an embodiment, a cast board made from the resin composition is mechanically tested and compared, and the urea-containing polyurethane acrylate resin of the disclosure exhibits at least comparable fundamental performance to an unmodified polyurethane acrylate resin (i.e., a polyurethane acrylate resin that does not contain a urea group); and in specific applications (such as composite material applications), the urea-containing polyurethane acrylate resin performs even better.

In an embodiment, the resin composition containing the urea-containing polyurethane acrylate resin may be mixed with other materials to form a composite material. For example, the resin composition of the embodiment (including the resin composition containing the urea-containing polyurethane acrylate resin) may be mixed with a fiber material to form a fiber reinforced polymer (FRP). The fiber material may include glass fiber, carbon fiber, polymer fiber (such as synthetic fiber), or other fibers. The fiber-reinforced polymer may have high strength and lightweight characteristics and is widely applied in fields such as aerospace, automotive, and construction.

In an embodiment, based on a total amount of 100 parts by weight of the resin composition, a total amount of the fiber material is from 67 parts by weight to 240 parts by weight.

In an embodiment, the fiber included in the composite material is carbon fiber, and the composite material may be a carbon fiber reinforced polymer (CFRP). Since the urea-containing polyurethane acrylate resin of the disclosure is modified by forming a urea group in the polyurethane acrylate resin structure, in the carbon fiber reinforced polymer, the modified urea group may generate polar interactions (such as hydrogen bonding) or bonding with the carbon fiber surface, thereby providing the composite material with improved inter-layer shear strength (ILSS), which may be comparable to or even superior to commercially available epoxy. Therefore, the urea-containing polyurethane acrylate resin and/or its resin composition of the disclosure may have broader applications and better quality.

In an embodiment, a mechanism for the improved adhesion may be attributed to the strong hydrogen bonding capability of the urea group (—NH—CO—NH—). Compared to a urethane group (—O—CO—NH—), the urea group possesses two N—H protons as hydrogen bond donors and a carbonyl oxygen as a hydrogen bond acceptor. This dual-functionality may allow for the formation of stronger and more numerous intermolecular hydrogen bonds with polar functional groups present on the surface of the carbon fiber (which is often surface-treated or sized to be more reactive). This enhanced interfacial interaction may be a factor in improving stress transfer between the resin matrix and the fiber reinforcement, thereby significantly increasing the inter-layer shear strength (ILSS) of the composite material.

In an embodiment, another aspect of the disclosure provides that a composite material, formed by impregnating a carbon fiber woven fabric with the urea-containing polyurethane acrylate resin, exhibits an average inter-layer shear strength of greater than or equal to 40 MPa. For example, the average inter-layer shear strength could be greater than or equal to 40.62 MPa; further, greater than or equal to 41.18 MPa; further, greater than or equal to 41.43 MPa; further, greater than or equal to 44.15 MPa; further, greater than or equal to 45.91 MPa; and even further, greater than or equal to 48.64 MPa. The shear strengths might be up to 50 MPa, better 55 MPa or even 60 MPa.

In an embodiment, the resin composition containing the urea-containing polyurethane acrylate resin may be dissolved in an appropriate solvent or a liquid curing agent (such as methyl ethyl ketone peroxide) and then used to impregnate the fiber material. Further, the composition can contain a curing promotor, better a cobalt salt, e.g. octanoic acid, cobalt salt.

### 6. EXAMPLES AND COMPARATIVE EXAMPLES

### 6.1 Preparation of the Resin Composition

### <Example 1> Resin Composition 1

280.0 grams of poly(methylene phenyl isocyanate) (brand: Wanhua; model: PM200; isocyanate group content: 2.083 equivalents), 0.106 grams of 2,6-di-tert-butyl-p-cresol (inhibitor), and 0.148 grams of dibutyltin dilaurate (catalyst) were dispersed in 363 grams of methyl methacrylate (diluent monomer) and uniformly mixed in a reaction kettle and heated to 45° C. to 60° C. for later use. Next, 125.0 grams of polypropylene glycol (brand: Oriental Union Chemical; average molecular weight: 400; hydroxyl group content: 0.625 equivalents) was added dropwise to the reaction kettle over a period of 40 minutes to 60 minutes, with the temperature maintained below 60° C. during the dropwise addition. After the dropwise addition was completed, the reaction was maintained at a constant temperature for 2 to 4 hours. Then, 180.75 grams of 2-hydroxyethyl methacrylate (HEMA, hydroxyl group content: 1.389 equivalents) was added dropwise over a period of 40 minutes to 60 minutes, with the temperature maintained below 60° C. After the dropwise addition was completed, the reaction was maintained at a constant temperature for 1 to 2 hours. Finally, 7.99 grams of polyetheramine (D230, average molecular weight: 230 g/mol; amine group content: 0.069 equivalents) was added dropwise to the reaction kettle over a period of 10 minutes to 30 minutes, with the temperature maintained below 60° C. during the dropwise addition. After the dropwise addition was completed, the reaction was maintained at a constant temperature for 1 to 2 hours. After confirming that the NCO value was below 0.5%, 90.75 grams of methyl methacrylate was added for dilution. The final product was a resin composition 1, with a viscosity of approximately 151 centipoise (cps).

### <Example 2> Resin Composition 2

The difference between Example 2 and Example 1 was that 7.99 grams of polyetheramine was replaced with 7.30 grams of 4,4′-diaminodicyclohexylmethane (amine group content: 0.069 equivalents). The final product after the reaction was a resin composition 2, with a viscosity of approximately 213 cps.

### <Example 3> Resin Composition 3

The difference between Example 3 and Example 1 was that 7.99 grams of polyetheramine was replaced with 5.92 grams of isophorone diamine (amine group content: 0.069 equivalents). The final product after the reaction was a resin composition 3, with a viscosity of approximately 128 cps.

### <Example 4> Resin Composition 4

The difference between Example 4 and Example 1 was that 7.99 grams of polyetheramine was replaced with 3.00 grams of piperazine (amine group content: 0.069 equivalents). The final product after the reaction was a resin composition 4, with a viscosity of approximately 133 cps.

### <Example 5> Resin Composition 5

The difference between Example 5 and Example 1 was that 7.99 grams of polyetheramine was replaced with 15.97 grams of polyetheramine (amine group content: 0.139 equivalents). The final product after the reaction was a resin composition 5, with a viscosity of approximately 190 cps.

### <Example 6> Resin Composition 6

The difference between Example 6 and Example 1 was that 7.99 grams of polyetheramine was replaced with 23.96 grams of polyetheramine (amine group content: 0.208 equivalents). The final product after the reaction was a resin composition 6, with a viscosity of approximately 239 cps.

### <Comparative Example 1> Resin Composition 7

The difference between Comparative Example 1 and Example 1 was that 125.0 grams of polypropylene glycol was replaced with 138.9 grams of polypropylene glycol (hydroxyl group content: 0.694 equivalents) and no amine compound was added. The final product after the reaction was a resin composition 7, with a viscosity of approximately 121 cps.

### 6.2 Preparation of the Composite Material

### <Example 7> Composite Material 1

Based on parts by weight, 100 parts by weight of Resin Composition 1 was taken, and 0.2 parts of 6% cobalt salt promoter and 1 part by weight of methyl ethyl ketone peroxide (MEKP) as curing agent were added. After thorough mixing, the mixture was impregnated into a commercially available carbon fiber woven fabric (brand: SHENG PENG APPLIED MATERIALS CO., LTD.; model: carbon fiber woven-3K, Type No. 3C118). The composite material was formed using vacuum assisted resin transfer molding (VARTM) and was cured at room temperature for 24 hours, followed by curing at 105° C. for 2 hours to achieve full curing, thereby obtaining the final product of Example 7.

### <Example 8> Composite Material 2

The difference between Example 8 and Example 7 was that the resin composition 2 was used instead of the resin composition 1.

### <Example 9> Composite Material 3

The difference between Example 9 and Example 7 was that the resin composition 3 was used instead of the resin composition 1.

### <Example 10> Composite Material 4

The difference between Example 10 and Example 7 was that the resin composition 4 was used instead of the resin composition 1.

### <Example 11> Composite Material 5

The difference between Example 11 and Example 7 was that the resin composition 5 was used instead of the resin composition 1.

### <Example 12> Composite Material 6

The difference between Example 12 and Example 7 was that the resin composition 6 was used instead of the resin composition 1.

### <Comparative Example 2> Composite Material 7

The difference between Comparative Example 2 and Example 7 was that the resin composition 7 was used instead of the resin composition 1.

### <Comparative Example 3> Composite Material 8

Based on parts by weight, 31 parts of a commercially available aliphatic polyetheramine curing agent (brand: Huntsman Corporation) was added to 100 parts of a bisphenol A/bisphenol F epoxy resin mixture (brand: Nan Ya Plastics). After thorough mixing, the mixture was impregnated into a commercially available carbon fiber woven fabric. Using the processing method, the composite material was formed and then cured at 40° C. for 8 hours, followed by curing at 70° C. for 8 hours to achieve full curing, thereby obtaining the final product of Comparative Example 3.

### <Comparative Example 4> Composite Material 9

Based on parts by weight, 100 parts of a commercially available bisphenol A-based vinyl resin (brand: SWANCOR) was added with 0.2 parts of 6% cobalt salt promoter, 0.05 parts of an accelerator N,N-dimethylaniline (DMA), and 1 part of methyl ethyl ketone peroxide. After thorough mixing, the mixture was impregnated into a commercially available carbon fiber woven fabric. Using the processing method, the composite material was formed and then cured at room temperature for 24 hours, followed by curing at 105° C. for 2 hours to achieve full curing, thereby obtaining the final product of Comparative Example 4.

### 6.3 Evaluation Items

### <Measurement of Average Inter-Layer Shear Strength (Unit: MPa)>

In accordance with ISO 14130, composite material products of <Example 7> to <Example 12> and <Comparative Example 2> to <Comparative Example 4> were each cut into five test samples with dimensions of 20 mm×10 mm×2 mm. Then, the inter-layer shear strength of the test samples was measured using a universal material testing machine (brand: Instron; model: 5892). The average value of the inter-layer shear strength was calculated, and the test results are shown in <Table 1> to <Table 3>.

### <Mechanical Performance Testing of Cast Boards>

Mechanical performance testing was conducted on the resin composition 1 to the resin composition 7 (with the same curing conditions as the composite material preparation: 0.2 parts of 6% cobalt salt promoter; 1 part of methyl ethyl ketone peroxide; cured at room temperature for 24 hours, followed by curing at 105° C. for 2 hours). The tensile test standard was ASTM D638, the flexural test standard was ASTM D790, and the heat deflection temperature test standard was ASTM D648. The specific test results are shown in Table 4.

TABLE 1
Comparison of Inter-Layer Shear Strength Between Urea-
Containing Polyurethane Acrylate Resin Composite Materials
Modified with Different Amine Compounds and Unmodified
Polyurethane Acrylate Resin Composite Materials

| | Exam- | Exam- | Exam- | Exam- | Comparative |
|---|---|---|---|---|---|
| | ple 7 | ple 8 | ple 9 | ple 10 | Example 2 |
| Fiber Content | 58 | 56 | 56 | 57 | 56 |
| (wt %) | | | | | |
| Inter-layer Shear | 41.43 | 41.18 | 40.62 | 44.15 | 39.03 |
| Strength (MPa) | | | | | |

As shown in <Table 1>, compared with unmodified polyurethane acrylate resin composite materials, urea-containing polyurethane acrylate resin composite materials exhibit superior inter-layer shear strength.

TABLE 2
Comparison of Inter-Layer Shear Strength Between Urea-Containing
Polyurethane Acrylate Resin Composite Materials Modified with
Different Amine Compounds and Epoxy Resin Composite Materials

| | Exam- | Exam- | Exam- | Exam- | Comparative |
|---|---|---|---|---|---|
| | ple 7 | ple 8 | ple 9 | ple 10 | Example 3 |
| Fiber Content (%) | 58 | 56 | 56 | 57 | 58 |
| Inter-layer Shear | 41.43 | 41.18 | 40.62 | 44.15 | 45.25 |
| Strength (MPa) | | | | | |

As shown in <Table 2>, epoxy resin has a highly polar structure and exhibits good inter-layer adhesion with carbon fiber. Therefore, it is generally known that epoxy resin composite materials have superior inter-layer shear strength. However, the urea-containing polyurethane acrylate resin composite materials may achieve inter-layer shear strength close to that of epoxy resin composite materials.

TABLE 3
Comparison of Inter-Layer Shear Strength Between Urea-Containing
Polyurethane Acrylate Resin Composite Materials Modified
with Different Ratios of Polyetheramine and Epoxy Resin
Composite Materials and Vinyl Resin Composite Materials

| | | | | Compar- | Compar- |
|---|---|---|---|---|---|
| | Exam- | Exam- | Exam- | ative | ative |
| | ple 7 | ple 11 | ple 12 | Example 3 | Example 4 |
| Resin Type | Polyurethane | | | Epoxy | Vinyl |
| | acrylate | | | | |
| Fiber Content (%) | 58 | 58 | 58 | 55 | 58 |
| Inter-layer Shear | 41.43 | 45.91 | 48.64 | 45.25 | 29.05 |
| Strength (MPa) | | | | | |

As shown in <Table 3>, increasing the equivalent number of reacted polyetheramine, which corresponds to increasing the urea group equivalent number in the polyurethane acrylate resin, effectively enhances adhesion between the carbon fiber and the resin. Moreover, the resulting inter-layer shear strength may even surpass that of epoxy resin composite materials.

TABLE 4
Mechanical Performance Testing

| | Example | Example | Example | Example | Example | Example | Comparative |
|---|---|---|---|---|---|---|---|
| | 1 | 2 | 3 | 4 | 5 | 6 | Example 1 |
| Tensile | 88.03 | 77.45 | 72.23 | 75.73 | 83.35 | 78.66 | 81.67 |
| Strength | | | | | | | |
| (MPa) | | | | | | | |
| Tensile | 3662 | 3491 | 3520 | 3488 | 3543 | 3619 | 3404 |
| Modulus | | | | | | | |
| (MPa) | | | | | | | |
| Elongation at | 5.31 | 3.83 | 3.29 | 3.33 | 4.60 | 3.30 | 4.25 |
| Break (%) | | | | | | | |
| Flexural | 157.71 | 144.39 | 147.46 | 145.92 | 155.60 | 154.57 | 150.23 |
| Strength | | | | | | | |
| (MPa) | | | | | | | |
| Flexural | 3791 | 3481 | 3590 | 3543 | 3677 | 3630 | 3551 |
| Modulus | | | | | | | |
| (MPa) | | | | | | | |
| Heat | 103.6 | 104.1 | 108.0 | 105.6 | 106.1 | 106.5 | 104.9 |
| Deflection | | | | | | | |
| Temperature | | | | | | | |
| (° C.) | | | | | | | |

As shown in <Table 4>, the mechanical properties of the modified urea-containing polyurethane acrylate resin are comparable to those of the unmodified polyurethane acrylate resin.

### 7. INDUSTRIAL APPLICABILITY

The modified urea-containing polyurethane acrylate resin composite materials of the embodiments in the disclosure may be directly or indirectly applied in fields such as aerospace, automotive, and construction. The modified urea-containing polyurethane acrylate resin may also be used to replace unmodified polyurethane acrylate resin, offering better quality and broader applicability.

What is claimed is:

1. A urea-containing polyurethane acrylate resin prepared by amidation of an isocyanate group in a polyurethane acrylate polymer with an amine compound to form a urea group, wherein the polyurethane acrylate polymer is prepared by reacting a hydroxyl-containing (meth)acrylate compound with a urethane prepolymer, the urethane prepolymer is prepared by reacting an isocyanate compound with a polyol compound, and the equivalent ratio of the isocyanate groups in the isocyanate compound to the hydroxyl groups in the polyol compound is 15:1 to 1:1.

2. The urea-containing polyurethane acrylate resin according to claim 1, wherein the amine compound comprises a dibutylamine, a polyetherdiamine, an isophorone diamine, a 4,4′-diaminodicyclohexylmethane, piperazine or combinations thereof.

3. The urea-containing polyurethane acrylate resin according to claim 1, wherein the isocyanate compound comprises three isocyanate groups.

4. The urea-containing polyurethane acrylate resin according to claim 3, wherein the isocyanate compound is not isophorone diisocyanate (IPDI).

5. The urea-containing polyurethane acrylate resin according to claim 1, wherein the equivalent ratio of the hydroxyl group in the polyol compound to an amine group in the amine compound is 9:1 to 7:3.

6. The urea-containing polyurethane acrylate resin according to claim 1, wherein the weight percentage of the isocyanate group in the urea-containing polyurethane acrylate resin is less than 0.5%.

7. A urea-containing polyurethane acrylate resin represented by the following [Formula 1]: 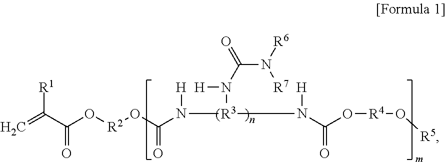
wherein in [Formula 1]:
R¹ is a hydrogen or a methyl group; R² is a connecting alkyl group having one to three carbon atoms; R³ is an organic group containing an aromatic group; R⁴ is an alkyl group, an alkenyl group, or an alkyl ether group; R⁵ is a connecting group represented by the following [Formula 2]: 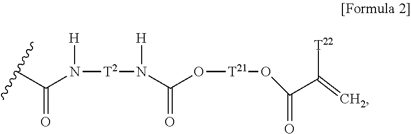
wherein in [Formula 2]:
T² is an organic group containing an aromatic group; T²¹ is an organic group; T²² and R⁶ are respectively a hydrogen or an organic group; R⁷ is a hydrogen or a cyclic organic group co-constructed with R⁶; and m and n are each an integer of 1 or more.

8. A composite material, comprising:
a resin composition comprising the urea-containing polyurethane acrylate resin according to claim 1 and a carbon fiber.

9. A composite material, comprising:
a resin composition comprising the urea-containing polyurethane acrylate resin according to claim 7 and a carbon fiber.

10. The composite material according to claim 8, wherein the resin composition further comprising a diluent monomer, wherein based on a total amount of 100 parts by weight of the urea-containing polyurethane acrylate resin, a total added amount of the diluent monomer is 30 parts by weight to 45 parts by weight.

11. The composite material according to claim 9, wherein the resin composition further comprising a diluent monomer, wherein based on a total amount of 100 parts by weight of the urea-containing polyurethane acrylate resin, a total added amount of the diluent monomer is 30 parts by weight to 45 parts by weight.

12. The composite material according to claim 8, wherein based on a total amount of 100 parts by weight of the resin composition, a total amount of the carbon fiber is 67 parts by weight to 240 parts by weight.

13. The composite material according to claim 9, wherein based on a total amount of 100 parts by weight of the resin composition, a total amount of the carbon fiber material is 67 parts by weight to 240 parts by weight.

14. The composite material according to claim 8, wherein the composite material has an inter-layer shear strength (ILSS) of greater than or equal to 40 MPa.

15. The composite material according to claim 9, wherein the composite material has an inter-layer shear strength (ILSS) of greater than or equal to 40 MPa.

16. The composite material according to claim 10, wherein the composite material has an inter-layer shear strength (ILSS) of greater than or equal to 40 MPa.

17. The composite material according to claim 11, wherein the composite material has an inter-layer shear strength (ILSS) of greater than or equal to 40 MPa.

18. A method for preparing a composite material, comprising applying a resin composition comprising the urea-containing polyurethane acrylate resin according to claim 1 to a carbon fiber.

19. A method for preparing a composite material, comprising applying a resin composition comprising the urea-containing polyurethane acrylate resin according to claim 7 to a carbon fiber.
